(19) United States
(12) Patent Application Publication
(10) Pub. No.: US 2014/0245897 A1
(43) Pub. Date: Sep. 4, 2014

(54) Rotisserie convection oven with rotatable cooking drum and method of use

(71) Applicant: George T.C. Li, Reno, NV (US)

(72) Inventor: George T.C. Li, Reno, NV (US)

(21) Appl. No.: 13/815,451

(22) Filed: Mar. 4, 2013

(51) Int. Cl. A47J 37/04

(52) U.S. Cl. CPC A47J 37/041
USPC 99/332; 99/421 R

(57) ABSTRACT

A rotisserie convection oven including a rotatable drum assembly which allows cooking of food items therein without added cooking oils is disclosed. The present oven is designed for cooking of pre-prepared or frozen foods with minimal ingestion of cooking oils and residual oil byproducts of concern to the health-conscious consumer. The present oven provides a countertop appliance having an enclosed cooking chamber with tubular heating elements wherein a rotatable drum containing foodstuffs is coupled to a rotisserie drive assembly. An integrated control chamber protects electrical components and encloses a convection fan assembly which is disposed in air transfer communication with the cooking chamber to enable circulation of air across the heating elements and through the rotatable drum during the cooking cycle. In one embodiment the rotatable drum is constructed of wire mesh to permit the continuous circulation of heated air therein to reduce cooking temperatures and shorten the cooking cycle.

### BACKGROUND OF THE INVENTION

The present invention relates to household appliances and, more particularly, to a rotisserie convection oven including a rotatable cooking drum and method of use, which allows cooking of pre-prepared and frozen foods within such cooking drum with minimal ingestion of cooking oils and cooking oil byproducts in the food items, which is of concern to the health-conscious consumer.

Portable kitchen countertop ovens with rotisserie mechanisms for cooking food items such as chicken, turkey, roasts and other foodstuffs are known in the prior art. However, such ovens typically utilize a gear driven bar and spit assembly having sharp spit rods whereon the food item is skewered and then placed in the oven for cooking. Such prior art countertop ovens are known to provide rotary cooking containers comprising a housing which is mounted on the rotisserie spit rods to support and rotate the container. Such prior art ovens often utilize tubular heating elements mounted within the cooking chamber of the oven for cooking. Tubular heating elements are constructed from metallic tubing wherein an electrical resistance heating wire is enclosed, which function to radiate heat for cooking within the cooking chamber. The tubular heating elements are normally disposed on the back and/or bottom walls of the cooking chamber and may provide Low and High heat settings for cooking.

Such a rotary drum for attachment to a prior art rotisserie mechanism has numerous disadvantages. Initially, mounting the rotating drum on a gear driven rotisserie mechanism commonly requires adapting the rotary drum to existing spit rod hardware which necessitates the fabrication of additional components and increased manufacturing complexity and costs.

In addition, such a prior art rotisserie oven typically includes a rotating basket or an enclosed rotary housing wherein the food items are disposed with added cooking oil and seasonings to effectively baste and stir fry the food items which become saturated with oil during the cooking process thereby adding to the heated cooking oil byproducts ingested by the user.

Further, such a prior art rotisserie oven typically provides only a single, enclosed cooking chamber wherein the food items are rotated in proximity to a radiant heating element without circulating heated air within the cooking chamber by convection to ensure a more uniform and efficient cooking process of shorter duration.

Thus, the rotisserie convection oven with a rotatable cooking drum of the present invention has been developed to solve these problems and other shortcomings of the prior art.

### DESCRIPTION OF THE PRIOR ART

U.S. Pat. No. 8,017,167 issued on Sep. 12, 2011, entitled Food Cooking Basket for A Rotisserie Oven discloses a portable oven with a rotisserie mechanism that accommodates a food basket and/or a rotary cooking container. Such cooking container is mounted on the rotisserie spit rod assembly to support and rotate the cooking container, which is a solid-walled (i.e. non-perforated) container designed to retain cooking oils and marinade for cooking food items. This oven utilizes an array of tubular heating rods mounted at the back wall of the cooking chamber of the oven, which can be selectively energized for radiant heating only. This rotisserie oven does not provide a perforated, rotating drum for circulation of heated air by convection through the rotating drum to ensure a uniform cooking process.

U.S. Pat. No. 7,973,264 issued on Jul. 5, 2011, entitled Toaster Oven with Low-Profile Heating Elements, by the same inventor named herein, discloses an optional rotisserie mechanism and a convection fan to reduce cooking temperature and to shorten cooking cycles. However, this patent does not disclose a rotatable cooking drum of perforated construction wherein foodstuffs are contained for cooking.

While these devices fulfill their respective, particular objectives and requirements, the aforementioned patents do not disclose the portable convection oven of the present invention including a rotating drum wherein heated air circulates to enhance the cooking process.

### SUMMARY OF THE INVENTION

Accordingly, the present invention is a rotisserie convection oven including a rotatable cooking drum which allows cooking of food items at lower cooking temperatures and shorter cooking cycles thereby eliminating the need for added cooking oils and marinades. The present oven is designed for cooking of pre-prepared or frozen foods such as French fries, fish sticks, chicken nuggets and other foodstuffs resulting in minimal ingestion of cooking oils, grease and cooking derived byproducts of concern to the health-conscious consumer.

The present rotisserie convection oven provides a kitchen countertop appliance which features an enclosed cooking chamber wherein a rotatable drum is detachably engaged with a rotisserie drive mechanism. The rotisserie drive motor and a convection fan are positioned in a protected control chamber disposed in air transfer communication with the cooking chamber to enable the circulation of heated air within the cooking chamber, which circulates through the rotating drum during the cooking cycle.

The present rotisserie convection oven provides a rotatable cooking drum which features both end-loading and side-loading of foodstuffs in alternative embodiments for the convenience of the user. The present rotatable cooking drum comprises a food container having a perforated cylindrical wall and/or perforated end caps permitting the circulation of heated air by the convection fan through the rotating drum to maximize cooking efficiency. A plurality of tubular heating elements disposed at predetermined locations within the cooking chamber can be selectively energized and cycled On and Off during the cooking cycle. An interior weir bar or baffle interrupts the continuous tumbling of food items in operation for maximum exposure to the heating elements. The present invention also provides a tool for removing the rotatable drum from the hot oven for the user's convenience.

There has thus been outlined, rather broadly, the important features of the present invention in order that the detailed description thereof that follows may be better understood, and in order that the present contribution to the art may be better appreciated. There are additional features of the invention that will be described hereinafter and which will form the subject matter of the claims appended hereto.

Those skilled in the art will appreciate that the conception upon which this disclosure is based may readily be utilized as a basis for the designing of other structures, methods, and systems for carrying out the purposes of the present invention. It is important, therefore, that the claims be regarded as including such equivalent constructions insofar as they do not depart from the spirit and scope of the present invention.

Other features and technical advantages of the present invention will become apparent from a study of the following description and the accompanying drawings.

### BRIEF DESCRIPTION OF THE DRAWINGS

The novel features of the present invention are set forth in the appended claims. The invention itself, however, as well as other features and advantages thereof will be best understood by reference to the following detailed description of an illustrative embodiment when read in conjunction with the accompanying figures, wherein:

FIG. 1 is a perspective view of the rotisserie convection oven of the present invention;

FIG. 2A is a perspective view of the present oven wherein the front door thereof is in an open position showing further details thereof;

FIG. 2B is a right side elevation view of the present oven wherein the outer wall has been removed for clarification;

FIG. 3 is a longitudinal cross-section taken along the section line 3-3 of FIG. 2A of the present oven showing further details thereof;

FIG. 4 is a perspective view of the cooking chamber of the present oven wherein the outer housing and door have been removed for clarification;

FIG. 5 is an exploded perspective view of the components within the present cooking chamber showing further details thereof;

FIG. 6A is an exploded perspective view of one embodiment of the rotatable drum of the present invention designed for end-loading;

FIG. 6B is an exploded perspective view of another embodiment of the rotatable drum of the present invention designed for side-loading;

FIG. 7A is a perspective view of another embodiment of the rotatable drum of the present invention designed for end-loading;

FIG. 7B is a perspective view of another embodiment of the rotatable drum of the present invention designed for side-loading;

FIG. 8A is a perspective view of a drum removal tool of the present invention;

FIG. 8B is a perspective view of a drum removal tool engaged with the rotatable drum illustrated in FIG. 6A; and

FIG. 9 is a schematic representation of the electrical components and circuitry of the present rotisserie convection oven.

### DETAILED DESCRIPTION OF THE PREFERRED EMBODIMENTS

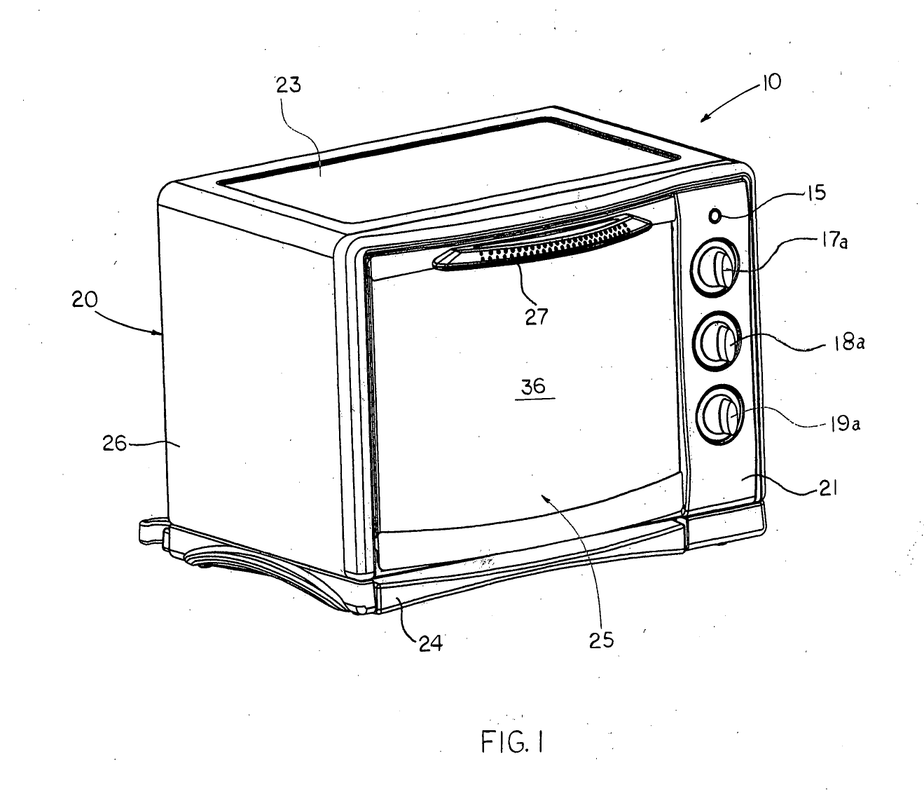

With further reference to the drawings there is shown therein an embodiment of a rotisserie convection oven with a rotatable cooking drum in accordance with the present invention, indicated generally at 10 and illustrated in FIG. 1, although it will be appreciated that the present invention is not limited in scope to this embodiment. The present oven 10 is comprised of an outer housing, indicated generally at 20, including a front door assembly, indicated generally at 25, which further includes a viewing window 36 and a door handle 27 for opening and closing door.

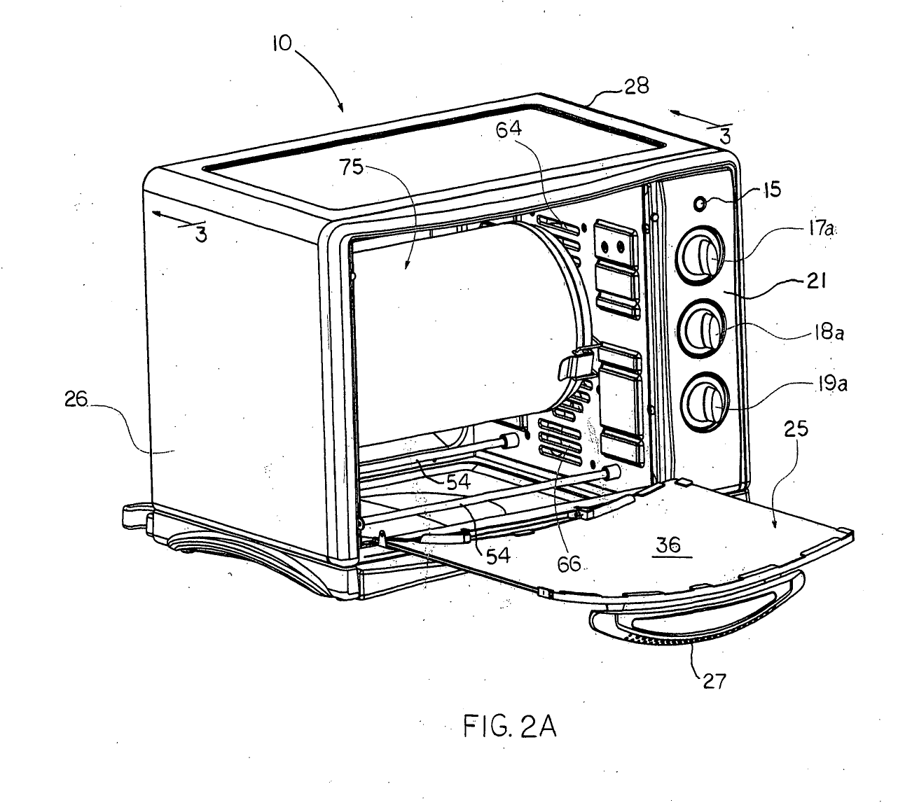

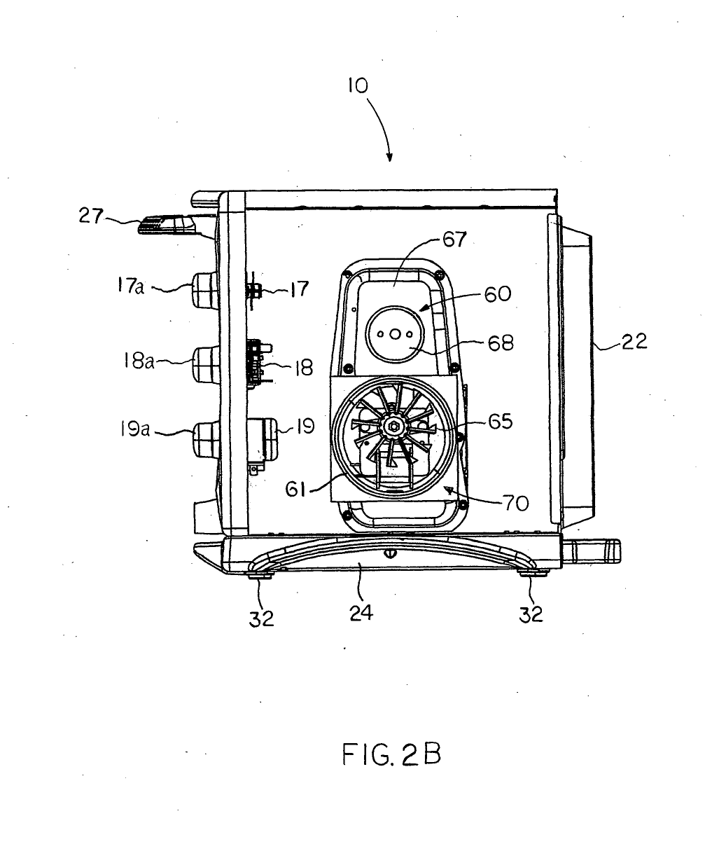

More particularly, outer housing 20 further comprises a front panel 21, top side 23, base 24, side walls 26, 28 and back wall 22 (FIG. 2A). The base 24 of housing 20 is provided with a plurality of feet 32 (FIG. 2B), which support the present oven 10 on a kitchen countertop or other working surface.

A temperature control selector switch 17a, a function control selector switch 18a and a timer control switch 19a are disposed on panel 21 of housing 20 to operate the respective heating controller 17, function controller 18 and timer 19 components and circuitry (FIG. 2B) to regulate the functions of the oven 10. An indicator light 15 on the front panel 21 is provided for the user's safety and convenience signaling that a cooking cycle is in progress. FIG. 2B also shows the position of the rotisserie drive assembly, indicated generally at 60 and the convection fan assembly, indicated generally at 70 as described hereinafter in further detail.

In an alternative embodiment of the present oven, a digital control panel (not illustrated) including a touch-screen interface with an integrated control circuit board, which is known in the prior art can be utilized to regulate the functions of the oven.

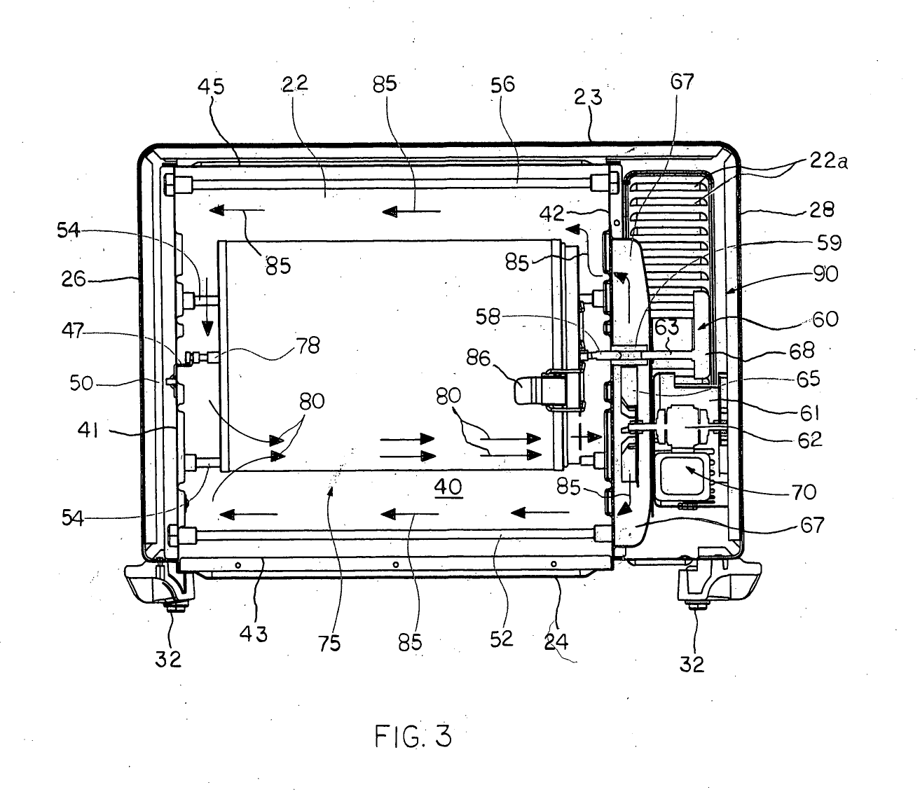

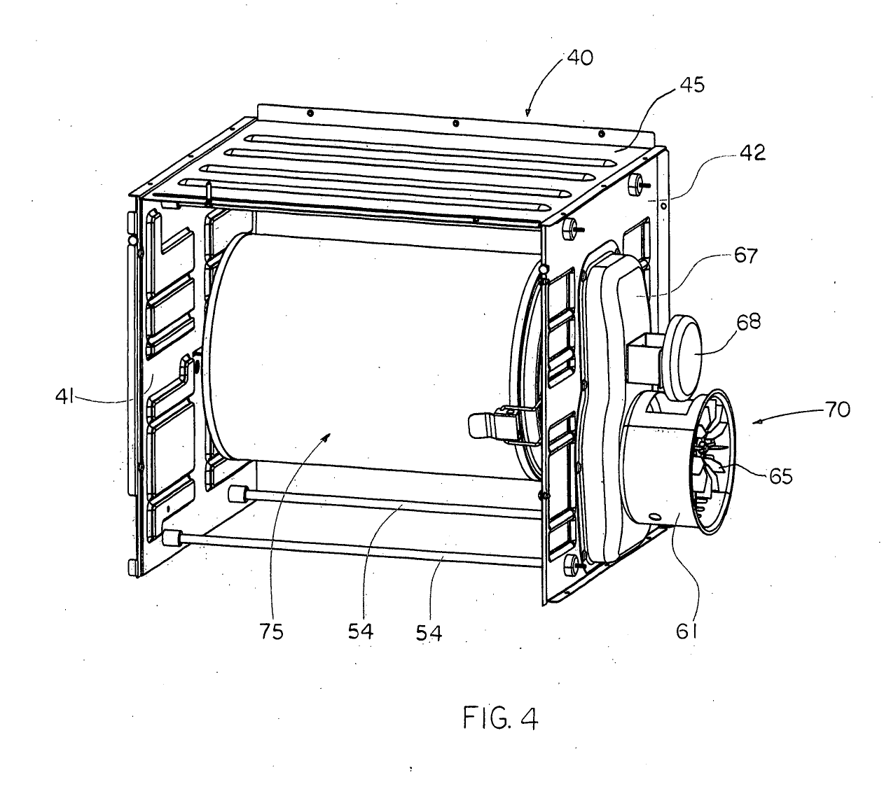

As further illustrated in FIGS. 3 and 4, a cooking chamber 40 comprises opposite sidewalls 41, 42, back wall 22, and top surface 45 wherein a rotatable drum assembly, indicated generally at 75, is detachably engaged. Chamber sidewalls 41, 42 are disposed in parallel to housing sidewalls 26, 28. Chamber top surface 45 is disposed in parallel to housing base 24 and top side 23 of housing 20 respectively. In the embodiment shown housing back wall 22 defines both the back of housing 20 and also the back of chamber 40 to simplify construction. Similarly, an upper surface of housing base 24 defines both the bottom of housing 20 and the bottom of cooking chamber 40 to simplify construction.

Housing sidewall 28, top wall 23, base 24, sidewall 42 and a portion of housing back wall 22 including vents 22a define a control chamber, indicated generally at 90 (FIG. 3). Control chamber 90 encloses the rotisserie drive assembly 60 including a rotisserie motor 68 including electrical circuitry, driveshaft 63, coupling 59 and stub axle 58, which engages and rotates drum assembly 75. It can be seen that control chamber 90 also encloses convection fan assembly 70 including a fan impeller 65, fan motor 62 including electrical circuitry and fan housing 61.

Still referring to FIG. 3 it will be appreciated the present oven 10 includes three pairs of horizontally disposed heating elements 52, 54, 56 which are arranged as shown within the cooking chamber 40. In this embodiment heating elements 52, 54, 56 are mounted in close proximity to back 22, base 24 and top surface 45 of chamber 40 (FIG. 4) in parallel relation and positioned in spaced-apart relation thereto.

In the embodiment shown in FIGS. 3 and 4, heating elements 52, 54, 56 are tubular type heating elements such as those manufactured under the trade name, CAL-ROD® or other suitable heating elements for this application. CALROD® heating elements 52, 54, 56 are typically comprised of stainless steel tubing, which encloses a resistance heating wire (not shown). Such CALROD heating elements 52, 54, 56 are well known in the appliance industry and further detailed description thereof is not deemed necessary.

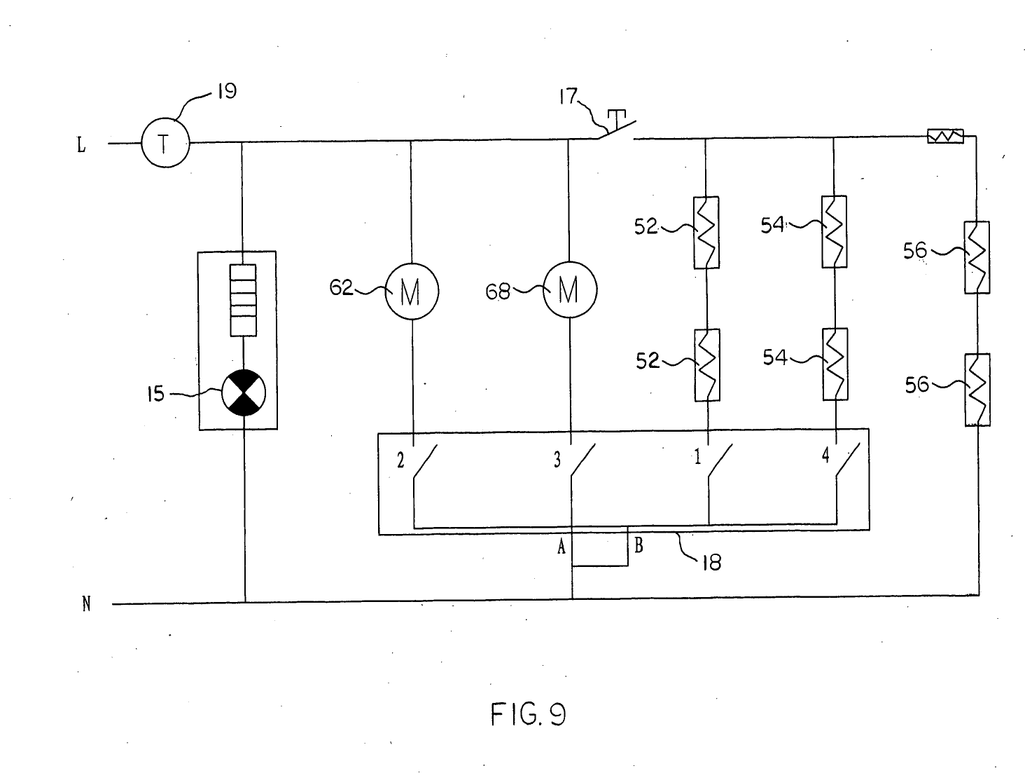

Heating elements 52, 54, 56 are electrically interconnected to the temperature controller 17, function controller 18 and timer 19 (FIG. 2B) to regulate the cooking functions of the oven 10. Heating elements 52, 54, 56 can be selectively energized by using temperature controller knob 17a and function controller knob 18a to activate each pair of heating elements separately or in combination to achieve the desired cooking temperature. Function controller 18 provides variable operating modes of the convection motor 62 and rotisserie motor 68 in conjunction with the heating elements 52, 54, 56 corresponding to “Broil, Convection, Bake, Rotisserie and Fryer” as illustrated in the electrical schematic in FIG. 9.

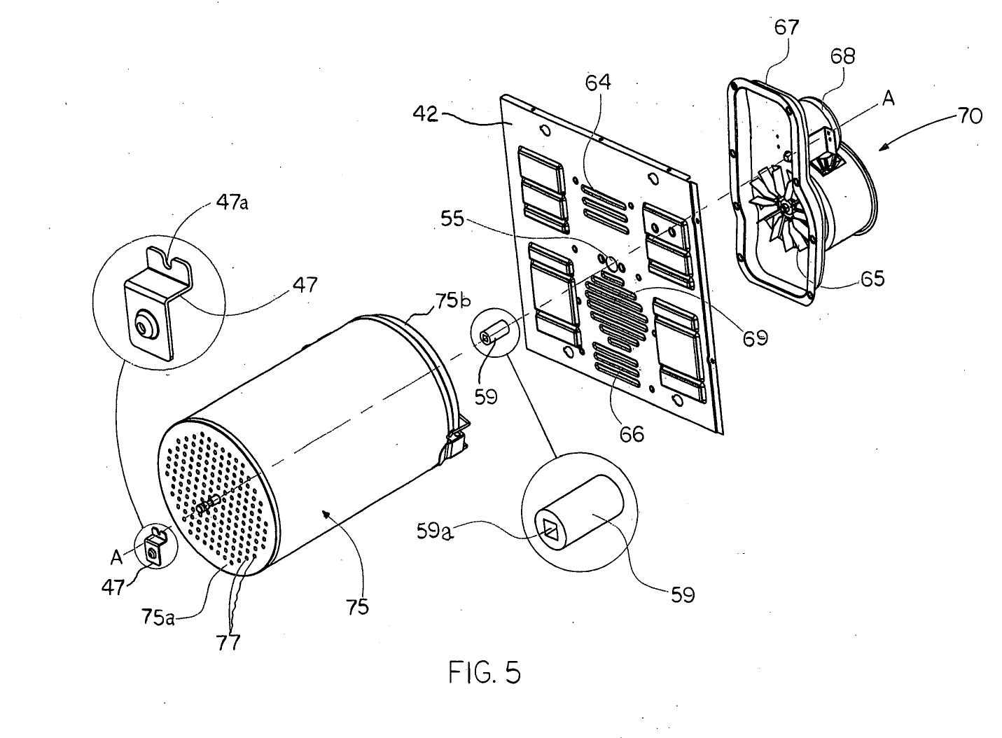

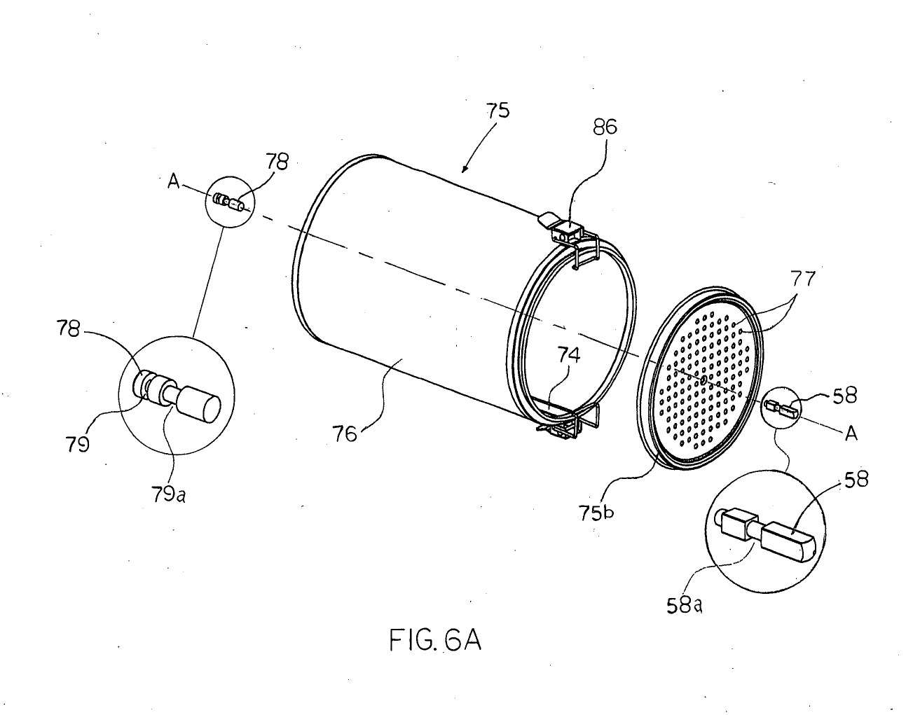

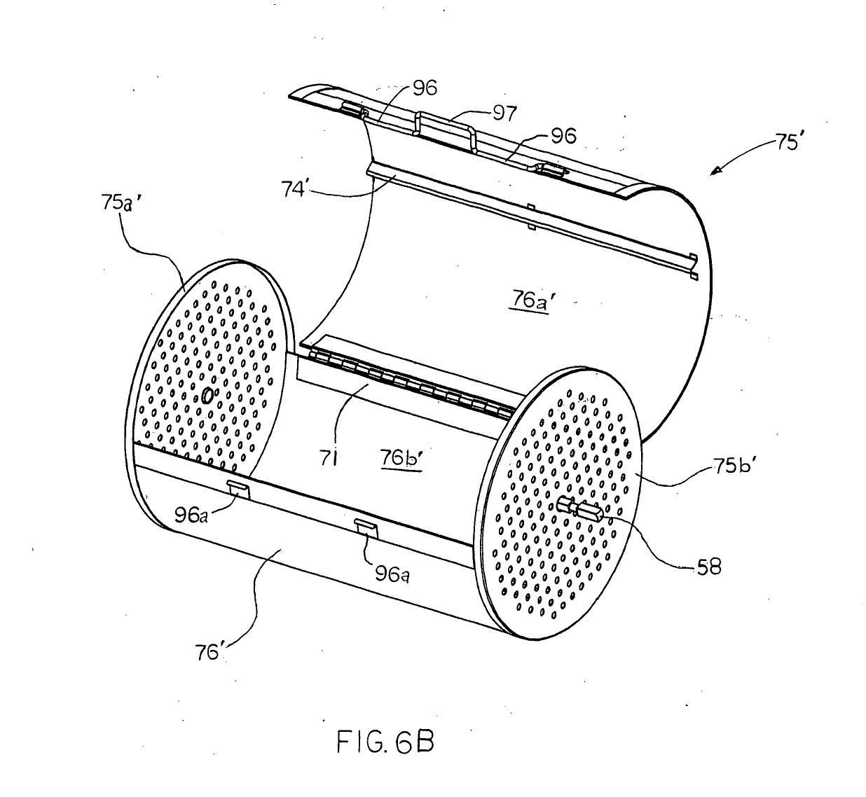

In a method of the present invention, cooking by convection occurs when the convection function is selected using controller 18 and heated air within oven 10 is forced into the cooking chamber 40 by fan impeller 65 on its output side via outlet vents 64, 66 (FIG. 5) and is circulated about the cooking chamber. As illustrated in FIG. 3, fan impeller 65 draws heated air (on its suction side) from cooking chamber 40, which passes through perforations 77 (FIG. 5) formed in the end caps 75a, 75b of the rotating drum 75 as shown by directional arrows 80. Drawn by fan impeller 65 heated air passes through rotating drum 75 heating food items contained therein and exits via end cap 75b (FIG. 6A) passing into air duct 67 via intake vent 69 (FIG. 5).

Fan impeller 65 (from its output side) continuously redirects the flow of heated air from duct 67 back into the cooking chamber 40 via outlet vents 64, 66 as shown in FIG. 3 by directional arrows 85. Air is circulated around heating elements 52, 54, 56 where it is reheated and again passes through the rotating drum 75 via perforations 77 (FIG. 5) and is drawn into inlet vents 69 on the suction side of the fan impeller 65. By continuously circulating heated air over a tumbling food item positioned within rotatable drum 75, the present oven 10 can operate at a lower temperature and cook food items more quickly than a comparable prior art rotisserie oven without convection heating.

In one embodiment shown in FIG. 6A, a drum assembly 75 of the end-loading type comprises a generally cylindrical body member 76 being fabricated of sheet metal whereon end caps 75a (FIG. 5), 75b having a plurality of perforations 77 are attached. At least one of such end caps 75b is removable from the body member 76 by use of operated clamps 86 in order to load pre-prepared or frozen foods such as French fries, fish sticks, chicken nuggets and other similar foodstuffs into the drum assembly 75 for cooking.

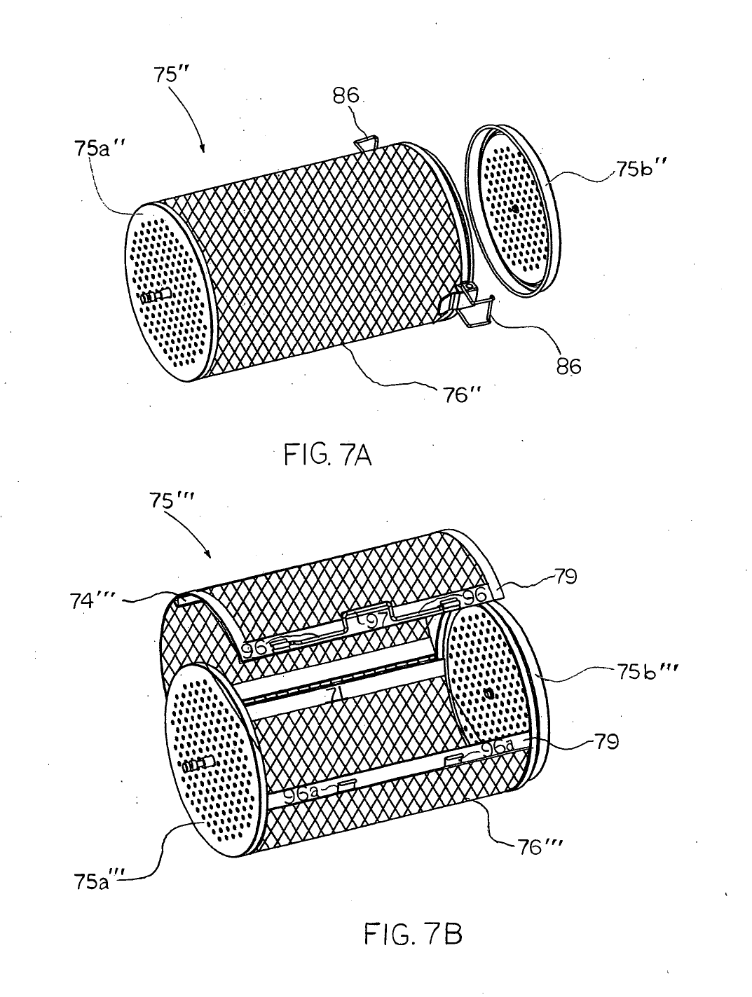

In an alternative embodiment a drum assembly 75′ of the side-loading type shown in FIG. 6B comprises a hinged body 76′ including upper and lower semi-cylindrical halves 76a′, 76b′. End caps 75a′, 75b′ each having a plurality of perforations 77 formed therein are permanently attached to lower body half 76b′ by weldment. Body halves 76a′, 76b′ are connected by a section of piano hinge 71 along the adjacent back edges thereof. The opposite front edge of body halves 76a′, 76b′ are secured in place by use of friction latches 96 integrated with a handle 97 (as more clearly shown in FIG. 7B). Latches 96 engage mating catches 96a installed on the front edge of lower body half 76b′ and are opened by manual pressure in order to load pre-prepared or frozen foods and other similar foodstuffs in the drum assembly 75′ for cooking.

Referring to FIG. 7A there is shown another embodiment of rotatable drum assembly 75″ of the end-loading type comprising a generally cylindrical body member 76″ being fabricated of wire mesh or expanded sheet metal whereon end caps 75a″, 75b″ having a plurality of perforations 77 are attached by weldment. Similarly, at least one of such end caps 75b″ is removable from the body member 76″ by use of clamps 86 in order to load foodstuffs into the drum assembly 75″ for cooking.

Another alternative embodiment of a rotatable drum assembly 75′ of the side-loading type shown in FIG. 7B comprises a hinged body 76′″ including upper and lower semi-cylindrical halves 76a′″, 76b′″ fabricated of air permeable, wire mesh or expanded sheet metal. End caps 75a′″, 75b′″ each having a plurality of perforations 77 formed therein are permanently attached to lower body half 76b′″ by weldment. Body halves 76a′″, 76b′″ are connected by a section of piano hinge 71 along the adjacent back edges thereof and secured by weldment. The opposite front edge of body halves 76a′″, 76b′″ are secured in place by use of friction latches 96 integrated with a handle 97. It can be seen that body halves 76a′″, 76b′″ each includes at least one reinforcing strip 79 fabricated of sheet metal to provide structural support for handle 97, latches 96 and mating catches 96a and to shield the edges off the wire mesh material. Latches 96 engage mating catches 96a installed on the front edge of lower body half 76b′″ and are opened by manual pressure in order to load pre-prepared or frozen foods and other similar foodstuffs in the drum 75′″ for cooking.

It can be seen that each drum assembly 75, 75′, 75″, 75′″ includes an interior weir bar or baffle 74 that is permanently attached to and extends the length thereof in parallel relation to axis—A—(FIG. 6A). Baffle 74 is designed to briefly hold a food item in position as such food item rotates past a given pair of heating elements 52, 54, 56. That is, baffle 74 momentarily interrupts or delays the continuous tumbling of foodstuffs during rotation of a drum assembly 75, 75′, 75″, 75′″ in the rotisserie mode. Such an interruption in the normal tumbling of foodstuffs within a rotating drum assembly 75, 75′, 75″, 75′″ has been observed to provide maximum exposure of food items to heating elements 52, 54, 56 in operation enabling more efficient cooking and shorter cooking cycles.

As seen in FIG. 6A a stub axle 58 having a square cross-section projects from mating coupling 59 (FIG. 5) through a hole 55 formed in cooking chamber side wall 42. Coupling 59 (FIG. 5) includes a square coaxial opening 59a that is dimensioned to a slip fit condition with stub axle 58. At an opposite end coupling 59 engages mating driveshaft 63 (FIG. 3) extending from the rotisserie motor 68. Stub axle 58 is received in a mating receptacle in the end cap 75b to drive the drum assembly 75 during operation in the rotisserie mode.

An opposite end cap 75a of drum assembly 75 receives an extension shaft 78 having a round cross-section (FIG. 6). Extension shaft 78 is received at its proximal end in a mating receptacle (not shown) in the end cap 75b to enable rotation of drum assembly 75 in operation. A distal end of extension shaft 78 includes a groove 79, which engages a mating bracket 47 having a slot 47a adapted to receive groove 79 on the extension shaft (FIG. 5). Bracket 47 is mounted with a fastener (not shown) on a side wall 41 of the cooking chamber 40 (FIG. 3) in alignment with axis—A—of drum assembly 75 and rotisserie drive assembly 60 to ensure rotation with minimal friction.

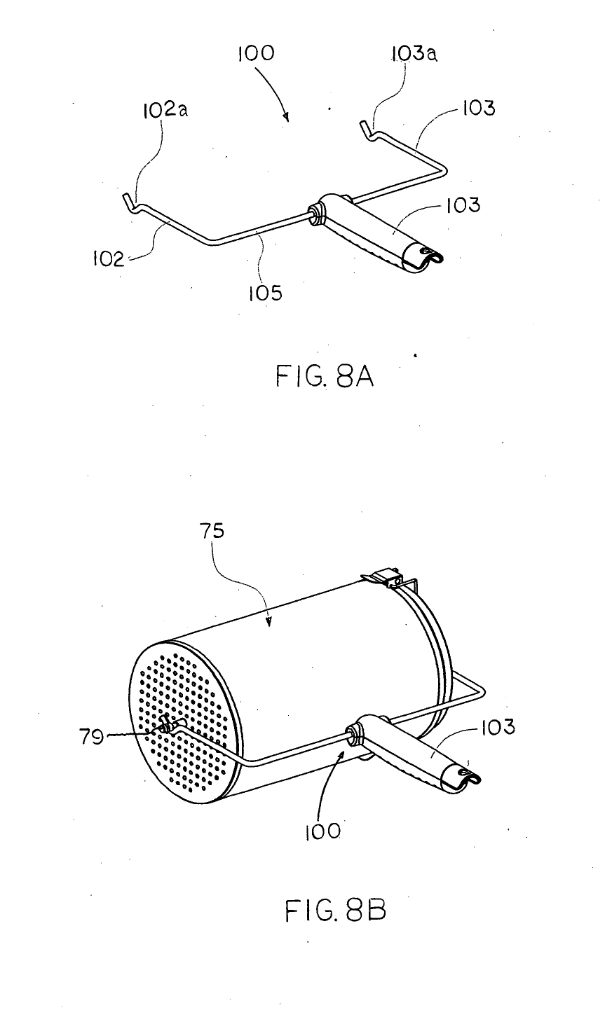

Both stub axle 58 and extension shaft 78 include a tool groove 58a, 78a respectively for engagement of drum removal tool, indicated generally at 100, (FIGS. 8A-8B) which allows the user to remove drum assemblies 75, 75′, 75″, 75′″ after a cooking cycle has been completed. Tool 100 is a generally U-shaped in configuration being fabricated from a heavy gauge wire or other suitable material. Tool 100 comprises a cross-member 105 having integrally formed, perpendicular arm members 102, 103. The distal ends of each arm member 102, 103 are bent into J-shaped hook portions 102a, 103a as shown in FIG. 8A. A handle 103 for tool 100 is fabricated from a heat-resistant material and is fixedly attached to a midpoint of cross-member 105 for the user's convenience. It will be appreciated that cross-member 105 and arm members 102, 103 are configured such that hook portions 102a, 103a engage tool groves 58a, 79a formed in the stub axle 58 and shaft 78 respectively as illustrated in FIG. 8B. Thus, tool 100 enables the user to lift and remove a loaded drum assembly 75, 75′, 75″ 75′″ from oven 10 when the drum assembly is too hot for direct manual contact by the user.

The electrical functions of rotisserie oven 10 can be carried out by the standard electromechanical controls as described hereinabove. Alternatively, the electrical functions of the rotisserie convection oven may be carried out by an electronic control panel (not shown) having a touch-based interface with an integrated control circuit board.

Referring to FIG. 9 there is shown therein a schematic representation of the electrical components and circuitry of the present rotisserie convection oven 10. Function controller 18 is electrically interconnected with timer 19, temperature controller 17, convection fan motor 62, rotisserie drive motor 68 and heating elements 52, 54 and 56. Function controller 18 provides variable operating modes of the convection motor 62 and rotisserie motor 68 in conjunction with the heating elements 52, 54, 56.

Heating elements 52, 54, 56 can be selectively energized by using temperature control selector switch 17a and function control selector switch 18a to activate each pair of heating elements separately or in combination to achieve a desired cooking mode (i.e. Broil, Convection, Bake, Rotisserie and Fryer modes) as understood by reference to the schematic drawing of FIG. 9.

With reference to electrical specifications, the wattage rating for the present rotisserie convection oven 10 can vary up to 1800 watts depending upon the selected function of the oven.

The present oven 10 is designed for use with standard residential electrical systems. An electrical cord and plug (not shown) are also provided to connect the present rotisserie convection oven 10 with a standard electrical outlet.

In accordance with the present invention the drum assemblies 75, 75′, 75″, 75′″ can be configured to fit various common sizes of commercially available rotisserie ovens and are suitable for retrofitting to such prior art rotisserie ovens to permanently replace conventional rotating baskets and rotisserie bar and spit assemblies.

Although not specifically illustrated in the drawings, it should be understood that additional equipment and structural components will be provided as necessary and that all of the components described above are arranged and supported in an appropriate fashion to form a complete and operative Rotisserie Convection Oven with Rotatable Drum incorporating features of the present invention.

Moreover, although illustrative embodiments of the invention have been described, a latitude of modification, change, and substitution is intended in the foregoing disclosure, and in certain instances some features of the invention will be employed without a corresponding use of other features. Accordingly, it is appropriate that the appended claims be construed broadly and in a manner consistent with the scope of invention.

What is claimed is:

1. A rotisserie convection oven comprising:
a housing including a cooking chamber;
a control chamber disposed within said housing in air transfer communication with said cooking chamber;
a rotisserie drive assembly disposed within said control chamber;
a rotatable drum assembly for containing foodstuffs disposed within said cooking chamber, wherein said drum assembly is mechanically coupled to said rotisserie drive assembly;
a convection fan assembly including a fan impeller disposed within said control chamber;
a plurality of heating elements arranged at predetermined positions within said cooking chamber,
a temperature controller electrically interconnected to said heating elements for regulating the cooking temperature thereof; and
a function controller electrically interconnected to said temperature controller, said rotisserie drive assembly and said convection fan assembly to provide variable operating modes of said convection fan motor and said rotisserie motor in combination with said heating elements.

2. The rotisserie convection oven of claim 1 wherein said cooking chamber comprises a top surface, a bottom surface, lateral sidewalls and a back wall extending between said top and bottom surfaces defining a forward facing opening, wherein a door member is disposed in closing relation to said opening.

3. The rotisserie convection oven of claim 2 wherein said control chamber is an enclosed compartment within said housing defined by at least one of said sidewalls of said cooking chamber and an interior wall of said housing, wherein said at least one of said sidewalls includes a plurality of intake vents and a plurality of outlet vents formed therein in air transfer communication with said cooking chamber.

4. The rotisserie convection oven of claim 1 further including a timer electrically interconnected to said temperature controller, said rotisserie drive assembly and said convection fan assembly to enable a timed cycle for operation thereof.

5. The rotisserie convection oven of claim 1 wherein said rotisserie drive assembly further includes a rotisserie motor having a driveshaft mechanically coupled to said rotatable drum within said cooking chamber.

6. The rotisserie convection oven of claim 3 wherein said convection fan assembly includes a convection fan motor whereon a fan impeller is installed, wherein said fan impeller is enclosed within an air duct disposed in air transfer communication with said plurality of intake vents and a plurality of outlet vents.

7. The rotisserie convection oven of claim 1 wherein said rotatable drum assembly further includes a generally cylindrical body member having a pair of perforated end caps to enable circulation of heated air therethrough.

8. The rotisserie convection oven of claim 7 wherein said body member of said drum assembly is fabricated from an air permeable wire mesh.

9. The rotisserie convection oven of claim 8 wherein at least one of said perforated end caps is detachable to provide end-loading of food items into said drum assembly.

10. The rotisserie convection oven of claim 8 wherein said body member is fabricated in semi-cylindrical halves being hinged on opposed lateral edges thereof to provide side-loading of food items into said drum assembly.

11. A rotisserie convection oven comprising:
(a) a housing including a cooking chamber;
(b) a control chamber;
(c) a rotisserie drive assembly including a rotisserie motor;
(d) a rotatable drum assembly;
(e) a convection fan assembly including a convection fan motor
(f) a plurality of heating elements;
(g) a temperature controller; and
(h) a function controller;
wherein said function controller is electrically interconnected to said temperature controller, said rotisserie drive motor and said convection fan motor to provide variable operating modes of said convection fan motor and said rotisserie motor in combination with said plurality of heating elements.

12. The rotisserie convection oven of claim 11 wherein said cooking chamber comprises a top surface, a bottom surface, lateral sidewalls and a back wall extending between said top and bottom surfaces defining a forward facing opening, wherein a door member is disposed in closing relation to said opening.

13. The rotisserie convection oven of claim 11 wherein said control chamber is an enclosed compartment within said housing defined by at least one of said sidewalls of said cooking chamber and an interior wall of said housing, wherein said at least one of said sidewalls includes a plurality of intake vents and a plurality of outlet vents formed therein in air transfer communication with said cooking chamber.

14. The rotisserie convection oven of claim 11 further including a timer electrically interconnected to said temperature controller, said rotisserie drive assembly and said convection fan assembly to enable operation thereof during a timed cycle.

15. The rotisserie convection oven of claim 11 wherein said rotisserie drive assembly further includes a driveshaft mechanically coupled to said rotatable drum assembly within said cooking chamber.

16. The rotisserie convection oven of claim 13 wherein said convection fan assembly includes a fan impeller enclosed within an air duct disposed in air transfer communication with said plurality of intake vents and a plurality of outlet vents.

17. The rotisserie convection oven of claim 11 wherein said rotatable drum assembly further includes a generally cylindrical body member having a pair of air permeable end caps to enable circulation of heated air therethrough.

18. The rotisserie convection oven of claim 17 wherein said body member of said drum assembly is fabricated from an air permeable wire mesh.

19. The rotisserie convection oven of claim 17 wherein at least one of said air permeable end caps is detachable to provide end-loading of food items into said drum assembly

20. The rotisserie convection oven of claim 18 wherein said body member is fabricated in semi-cylindrical halves being hinged on opposed lateral edges thereof to provide side-loading of food items into said drum assembly.
